(19) United States
(12) Patent Application Publication
(10) Pub. No.: US 2004/0096641 A1
(43) Pub. Date: May 20, 2004

(54) Foam laminate, method for production and use thereof

(76) Inventors: Maxime Allard, Burgo di Molgora (IT); Giordano Staid, Locate di Trialzi (IT)

Correspondence Address: BASF CORPORATION, ANNE GERRY SABOURIN, 26701 TELEGRAPH ROAD, SOUTHFIELD, MI, 48034-2442, US

(21) Appl. No.: 10/433,127

(22) PCT Filed: Dec. 18, 2001
(86) PCT No.: PCT/EP01/14914

(30) Foreign Application Priority Data
Dec. 18, 2000 (DE) 100 63 158.4

(51) Int. Cl. B32B 3/26; B32B 7/12; B32B 9/00; B32B 15/04

(52) U.S. Cl. 428/304.4; 428/318.4; 428/317.3; 428/354

(57) ABSTRACT

A foam laminate comprising

a layer of a foam sealed by an outer skin consisting of or containing natural rubber or synthetic rubber, and at least one clearcoat cured with actinic radiation, and also, if desired, between the underside of the clearcoat and the outer skin, a physically cured basecoat and/or on its side opposite the clearcoat, or opposite the clearcoat and basecoat, an adhesive film, which is curable with actinic radiation, physically setting, contains nanoparticles and at least one tackifier, or a layer of a foam sealed by an outer skin, and at least one clearcoat cured with actinic radiation, an adhesive curable with actinic, which is physically setting, contains nanoparticles and at least one tackifier, on the side of the foam layer(s) facing away from the clearcoat or basecoat and clearcoat, and also, if desired, between the underside of the clearcoat and the outer skin, a physically cured basecoat. Method for producing and use of the foam laminate for decorative, signaling and/or thermally, magnetically and/or electrically insulating coating of articles, especially buildings, industrial installations, or parts thereof.

The present invention relates to a novel foam laminate. The present invention further relates to a novel process for producing a foam laminate. The present invention additionally relates to the use of the novel foam laminate for decorative, signaling and/or thermally, magnetically and/or electrically insulating coating of articles, especially buildings, industrial installations, or parts thereof.

Foam laminates are used worldwide for insulating pipes or the interior and exterior of buildings and for sealing doors and windows. In these applications, preference is given to the use of foams made from styrene-butadiene rubber (“SBR”). For this purpose, SBR is foamed with gases in the presence of flame retardants.

The resulting SBR foam, however, has a very sensitive outer skin, possessing only low abrasion resistance, scratch resistance, and weathering stability. Any scratch may destroy the outer skin, after which the foam laminates must be replaced by new ones. To prevent this, the foam laminates must be provided by hand with a coating, in the case of exterior application, or bonded to an aluminum foil at the factory prior to their application. These measures considerably increase the costs of an insulation system. Moreover, inspection at least once a year is required, and possibly reconditioning or repair, or even the replacement of the insulation. These drawbacks hinder widespread use of the SBR foam laminates. Furthermore, the existing SBR foam laminates are not suitable for decorative purposes.

The British patent application GB 2038241 A discloses a foam laminate, which comprises a foam layer based on PVC, a color coating and at least one clearcoat curable with actinic radiation. The foam laminates may comprise a support or substrate, for example of flexible foil. Suitable flexible supports may be produced from flexible polar or from lower flexible woven textiles and watertight material. For this woven cellulose or woven asbestos waterproofed are advantageous. However these known foam laminates may not be connected to articles, especially buildings, industrial installations, or parts thereof easily.

It is an object of the present invention to provide novel foam laminates which no longer have the disadvantages of the prior art but which instead have an outer surface which is abrasion resistant, scratch resistant and stable to weathering, so that they need no longer be provided by hand with protective coatings or provided at the factory with an aluminum foil. Furthermore, the intention is that the novel foam laminates should have a considerably longer lifetime than the existing ones, so that there is no need for periodic inspections and, if appropriate, repairs or the replacement of the insulation. Furthermore, the adhesive layers of the novel foam laminates should be stable to heat and also not lose their adhesive strength after warming to 190° C. for 6 hours.

Accordingly, the novel foam laminate comprising at least one layer of a foam sealed by an outer skin consisting of or containing natural rubber or synthetic rubber, and at least one clearcoat cured with actinic radiation was found.

Also, the novel foam laminate comprising at least one layer of a foam sealed by an outer skin consisting, at least one clearcoat cured with actinic radiation and an adhesive film on its side facing away from the clearcoat, said adhesive film being curable with actinic radiation, physically setting, containing nanoparticles and at least one tackifier, was found.

Hereinafter the novel foam laminates are referred to below as the “laminate of the invention”.

Further, the novel method of producing a foam laminate was found, wherein at least one clearcoat material curable with actinic radiation is applied to the outer skin of one side of the foam layer, or one side of the outer foam layer, consisting of or containing natural rubber or synthetic rubber, or to a color and/or effect coating which is present thereon, and cured with actinic radiation.

Furthermore, the novel method of producing a foam laminate was found, wherein

(i) at least one clearcoat material curable with actinic radiation is applied to the outer skin of one side of the foam layer, or one side of the outer foam layer, or to a color and/or effect coating which is present thereon, and cured with actinic radiation and

(ii) an adhesive curable with actinic radiation is applied to side of the foam layer(s) facing away from the clearcoat or basecoat and clearcoat and the resulting adhesive film is cured with actinic radiation or alternatively the adhesive is applied to a temporary support, the resulting adhesive film is cured with actinic radiation and the resulting physically setting, self-supporting adhesive sheet, is joined to said side of the foam layer(s) before or after its removal from the temporary support.

Hereinafter the novel methods of producing a foam laminate are referred to below as the “method of the invention”.

The laminates of the invention may be of any desired three-dimensional form. Preferably, however, at least one of their surfaces or sides is substantially or completely planar, so that they may be connected to the planar faces of other articles, for example, for decorative, protective and/or heat insulation purposes. The surface or side opposite this surface or side, on the other hand, may be contoured. For example, it may feature decorative three-dimensional ornamentation or structures which absorb sound, for example. With particular preference, the laminates of the invention are overall substantially or completely planar.

The laminate of the invention comprises at least one layer of a foam sealed by an outer skin. In general, one foam layer is sufficient for the structure and the application of the laminate of the invention.

Foams in accordance with DIN 7726: 1982-05 are materials with open and/or closed cells distributed over their entire mass and a foam density which is lower than that of the framework substance. Preference is given to the use of elastic and flexible foams in accordance with DIN 53580 (cf. also Römpp Lexikon Chemie, CD-ROM: Version 2.0, Georg Thieme Verlag, Stuttgart, N.Y., 1999, “Foams”).

The foam comprises or consists of at least one, in particular one, synthetic or naturally occurring polymer. Examples of suitable polymers are natural rubber, ABS, AMMA, ASA, CA, CAB, EP, UF, CF, MF, MPF, PF, PAN, PA, PE, HDPE, LDPE, LLDPE, UHMWPE, PC, PC/PBT, PC/PA, PET, PMMA, PP, PS, SB, SBR, PUR, PVC, RF, SAN, PBT, PPE, POM, PUR-RIM, SMC, BMC, PP-EPDM and UP (abbreviations in accordance with DIN 7728T1). It is preferred to use foams made from rubbers, preferably synthetic rubbers, especially SBR.

The production of these foams has no special features but instead takes place in a customary and known manner by foaming of the plastics with suitable inert gases such as steam, nitrogen, carbon dioxide, pentane or chlorinated and/or fluorinated hydrocarbons in open or closed vessels. The processes are implemented so as to form foams having a continuous outer skin.

On the surface or side which subsequently, in the intended utility, forms the outer surface or outer side, the laminate of the invention has at least one, in particular one, clearcoat cured with actinic radiation.

Here and below, actinic radiation means electromagnetic radiation such as near infrared (NIR), visible light, UV radiation and X-rays, especially UV radiation, and also corpuscular radiation such as electron beams. Preferably, UV radiation is employed.

The clearcoat material curable with actinic radiation that is used to produce the clearcoat may be an aqueous clearcoat material, a conventional clearcoat material, a substantially water- and solvent-free clearcoat material (100% system), a substantially water- and solvent-free powder clearcoat material, or a substantially solvent-free powder- clearcoat slurry. Preference is given to the use of a substantially water- and solvent-free 100% system.

Examples of suitable clearcoat materials curable with actinic radiation are disclosed, for example, in the patent applications and patent EP 0 540 884 A1, EP 0 568 967 A1, DE 199 20 801 A1 and U.S. Pat. No. 4,675,234 A.

It is preferred to use a clearcoat material curable with actinic radiation and comprising

at least one binder comprising on average per molecule at least one reactive functional group containing a bond which can be activated with actinic radiation (“clearcoat binder”),

at least one low molecular mass compound containing at least one reactive functional group containing a bond which can be activated with actinic radiation (“reactive diluent”), and

at least one photoinitiator.

The clearcoat binders comprise on average at least one, in particular at least two, reactive functional group(s) containing a bond which can be activated with actinic radiation. Below, the reactive functional groups are referred to as “radiation-curable groups”.

Examples of suitable bonds which can be activated with actinic radiation are carbon-hydrogen single bonds or carbon-carbon, carbon-oxygen, carbon-nitrogen, carbon-phosphorus or carbon-silicon single bonds or double bonds. Of these, the carbon-carbon double bonds are particularly advantageous and are therefore used with very particular preference in accordance with the invention. For the sake of brevity, they are referred to below as “double bonds”.

The double bonds are preferably present in reactive functional groups such as (meth)acrylate, ethacrylate, crotonate, cinnamate, vinyl ether, vinyl ester, dicyclopentadienyl, norbornenyl, isoprenyl, isopropenyl, allyl or butenyl groups; dicyclopentadienyl ether, norbornenyl ether, isoprenyl ether, isopropenyl ether, allyl ether or butenyl ether groups; or dicyclopentadienyl ester, norbornenyl ester, isoprenyl ester, isopropenyl ester, allyl ester or butenyl ester groups, but (meth)acrylate groups in particular, especially acrylate groups.

Where the clearcoat binders contain more than one, in particular two, radiation-curable groups(s), these groups may be identical to or different from one another. Preferably, the radiation-curable groups are identical.

The clearcoat binders are oligomeric or polymeric compounds.

An oligomeric compound is a compound having on average from 2 to 15 monomer units. A polymeric compound, in contrast, is a compound having on average at least 10 monomer units.

In contradistinction thereto, a low molecular mass compound is a compound derived essentially from only one parent structure or one monomer unit. Compounds of this kind are generally referred to by those in the art as reactive diluents.

The polymers or oligomers used as clearcoat binders usually have a number average molecular weight of from 500 to 50,000, preferably from 1000 to 5000. They preferably have a double bond equivalent weight of from 400 to 2000, with particular preference from 500 to 900. Additionally, they have a viscosity at 23° C. of preferably from 250 to 11,000 mPas. They are preferably employed in an amount of from 5 to 90% by weight, with particular preference from 7 to 80% by weight, and in particular from 10 to 70% by weight, based in each case on the overall amount of the clearcoat material.

Examples of suitable clearcoat binders come from the oligomer and/or polymer classes of the (meth)acryloyl-functional (meth)acrylate copolymers, polyether acrylates, polyester acrylates, polyesters, epoxy acrylates, urethane acrylates, amino acrylates, melamine acrylates, silicone acrylates and phosphazene acrylates and the corresponding methacrylates. It is preferred to use clearcoat binders which are free from aromatic structural units. Preference is therefore given to the use of urethane (meth)acrylates, polyether (meth)acrylates, phosphazene (meth)acrylates and/or polyester (meth)acrylates, with particular preference being given to urethane (meth)acrylates and polyether (meth)acrylates, especially aliphatic urethane (meth)acrylates.

The urethane (meth)acrylates are obtained by reacting a diisocyanate or polyisocyanate with a chain extender from the group of the diols/polyols and/or diamines/polyamines and/or dithiols/polythiols and/or alkanolamines and then reacting the remaining free isocyanate groups with at least one hydroxyalkyl (meth)acrylate or hydroxyalkyl ester of other ethylenically unsaturated carboxylic acids.

The amounts of chain extender, diisocyanate or polyisocyanate, and hydroxyalkyl ester in this case are preferably chosen so that

1.) the ratio of equivalents of the NCO groups to the reactive groups of the chain extender (hydroxyl, amino and/or mercaptyl groups) is between 3:1 and 1:2, preferably 2:1, and

2.) the OH groups of the hydroxyalkyl esters of the ethylenically unsaturated carboxylic acids are stoichiometric with regard to the remaining free isocyanate groups of the prepolymer formed from isocyanate and chain extender.

It is also possible to prepare the urethane (meth)acrylates by first reacting some of the isocyanate groups of a diisocyanate or polyisocyanate with at least one hydroxyalkyl ester and then reacting the remaining isocyanate groups with a chain extender. In this case too the amounts of chain extender, isocyanate and hydroxyalkyl ester are chosen such that the ratio of equivalents of the NCO groups to the reactive groups of the chain extender is between 3:1 and 1:2, preferably 2:1, and the ratio of equivalents of the remaining NCO groups to the OH groups of the hydroxyalkyl ester is 1:1. All of the forms lying between these two processes are of course also possible. For example, some of the isocyanate groups of a diisocyanate may be reacted first of all with a diol, after which a further portion of the isocyanate groups may be reacted with the hydroxyalkyl ester, and, subsequently, the remaining isocyanate groups may be reacted with a diamine.

These various preparation processes for the urethane (meth)acrylates are known, (compare, for example, EP 0 204 161 A1).

The urethane (meth)acrylates may be flexibilized, for example, by reacting corresponding isocyanate-functional prepolymers or oligomers with relatively long-chain aliphatic diols and/or diamines, especially aliphatic diols and/or diamines having at least 6 carbon atoms. This flexibilization reaction may be carried out before or after the addition of acrylic and/or methacrylic acid onto the oligomers and/or prepolymers.

Further examples which may be mentioned of suitable urethane (meth)acrylates are the following, commercially available polyfunctional aliphatic urethane acrylates:

Crodamer® UVU 300 from Croda Resins Ltd., Kent, United Kingdom;

Genomer® 4302, 4235, 4297 or 4316 from Rahn Chemie, Switzerland;

Ebecryl® 284, 270, 244, 230, 294, IRR351, 5129 or 1290 from UCB, Drogenbos, Belgium;

Roskydal® LS 2989 or LS 2545 or V94-504 from Bayer AG, Germany;

CN960, CN965, CN970 or CN980 from Cray Valley, France

Viaktin® VTE 6160 from Vianova, Austria; or

Laromer® 8861 or PUA 8739 from BASF AG, and experimental products modified from it.

Examples of suitable polyether (meth)acrylates are the products sold by Cognis under the brand name Photomer® 6891 or RCC891.

One example of a suitable polyphosphazene (meth)acrylate is the phosphazene dimethacrylate from Idemitsu, Japan.

Examples of suitable reactive diluents are (meth)acrylic acid and its esters, maleic acid and its esters, including monoesters, vinyl acetate, vinyl ethers, vinylureas, and the like. Examples that may be mentioned include alkylene glycol di(meth)acrylate, polyethylene glycol di (meth) acrylate, 1,3-butanediol di(meth)acrylate, vinyl (meth)acrylate, allyl (meth)acrylate, glycerol tri(meth)acrylate, trimethylolpropane tri(meth)acrylate, trimethylolpropane di(meth)acrylate, styrene, vinyltoluene, divinylbenzene, pentaerythritol tri(meth)acrylate, pentaerythritol tetra(meth)acrylate, dipentaerythritol pentaacrylate, dipropylene glycol di(meth)acrylate, hexanediol di (meth) acrylate, ethoxyethoxyethyl acrylate, tridecyl acrylate, cyclohexyl acrylate, tert-butylcyclohexyl acrylate, N-vinylpyrrolidone, phenoxyethyl acrylate, dimethylaminoethyl acrylate, hydroxyethyl (meth)acrylate, butoxyethyl acrylate, isobornyl (meth)acrylate, dimethylacrylamide and dicyclopentyl acrylate, and the long-chain linear diacrylates that are described in EP 0 250 631 A1, having a molecular weight of from 400 to 4000, preferably from 600 to 2500. For example, the two acrylate groups may be separated by a polyoxybutylene structure. It is further possible to use 1,12-dodecyl diacrylate and the reaction product of 2 mols of acrylic acid with one mole of a dimeric fatty alcohol having generally 36 carbon atoms. Further examples of suitable reactive diluents are known from Römpp Lexikon Lacke und Druckfarben, Georg Thieme Verlag, Stuttgart, N.Y., 1998, “Reactive diluents”, page 491. Also suitable are mixtures of the abovementioned reactive diluents.

Preferred reactive diluents used are monoacrylates and/or diacrylates, such as, for example, isobornyl acrylate, hexanediol diacrylate, tridecyl acrylate, tert-butylcyclohexyl acrylate, tripropylene glycol diacrylate, Laromer® 8887 from BASF AG, and Actilane® 411 from Akcros Chemicals Ltd., UK. Particular preference is given to the use of isobornyl acrylate, tridecyl acrylate, hexanediol diacrylate, and tripropylene glycol diacrylate.

The reactive diluents are employed in an amount of preferably from 0.5 to 30% by weight, with particular preference from 1.0 to 25% by weight, and in particular from 1.5 to 20% by weight, based in each case on the overall amount of the clearcoat material.

The clearcoat material further comprises at least one photoinitiator.

Examples of suitable photoinitiators are those of the Norrish II type, whose mechanism of action is based on an intramolecular variant of the hydrogen abstraction reactions as occur diversely in photochemical reactions or cationic photoinitiators, as described for example in Römpp Chemie Lexikon, 9th, expanded and revised edition, Georg Thieme Verlag Stuttgart, Vol. 4, 1991, or Römpp Lexikon Lacke und Druckfarben, Georg Thieme Verlag Stuttgart, 1998, pages 444 to 446, especially benzophenones, benzoins or benzoin ethers, or phosphine oxides. It is also possible to use, for example, the products available commercially under the names Irgacure® 184, Irgacure® 1800 and Irgacure® 500 from Ciba Geigy, Genocure® MBF from Rahn, and Lucirin® TPO from BASF AG. The photoinitiator content of the clearcoat material is preferably from 0.1 to 5, more preferably from 0.2 to 4.5, with particular preference from 0.3 to 4, with very particular preference from 0.4 to 3.5 and in particular from 0.5 to 36 by weight, based in each case on the overall amount of the clearcoat material.

The clearcoat material may further comprise at least one transparent filler, preferably in an amount of from 5 to 50, more preferably from 6 to 45, and in particular from 8 to 40% by weight, based on the overall amount of the clearcoat material.

Examples of suitable transparent fillers are those based on silicon dioxide, aluminum oxide, especially aluminum hydroxide (Al₂O₃×n H₂O) or zirconium oxide; for further details, reference is made to Römpp Lexikon Lacke und Druckfarben, Georg Thieme Verlag, Stuttgart, 1998, pages 250 to 252.

The fillers may in part also be present as -nanoparticles. Particularly suitable nanoparticles are those based on silicon dioxide with a particle size <50 nm, in particular from 15 to 30 nm, which have no flatting effect. Examples of suitable silicon dioxide-based nanoparticles are pyrogenic silicas, which are sold as dispersions under the trade name Aerosil® VP8200, VP711 or R972 by the company Degussa or the trade names Cab O Sil® TS 610, CT 1110F or CT 1110G by the company CABOT, the trade name High Link® OG 103-31, OG 102-31 or OG 502-31 by the company Clariant Hoechst, or the trade name Snowtex® MIBK or IPA by the company Nissan.

In general, these nanoparticles are sold in the form of dispersions in alcohols such as isopropanol, ketones such as methyl isobutyl ketone, or in monomers curable with actinic radiation (reactive diluents). Examples of suitable monomers which are especially suitable for the present purpose are alkoxylated pentaerythritol tetraacrylate or triacrylate, ditrimethylolpropane tetra acrylate or triacrylate, dineopentyl glycol diacrylate, trimethylolpropane triacrylate, tris-hydroxyethylisocyanurate triacrylate, dipentaerythritol pentaacrylate or hexaacrylate, or hexanediol diacrylate. In general, these dispersions contain the nanoparticles in an amount, based in each case on the dispersions, of from 10 to 80% by weight, preferably from 15 to 70% by weight, with particular preference from 20 to 60% by weight, and in particular from 25 to 55% by weight. Preference is given to the use of dispersions in isopropanol. An example of a nanoparticle dispersion especially suitable in accordance with the invention is the dispersion sold by the company Clarion Hoechst under the trade name High Link® OG 502-31.

Where the clearcoat material is used to produce laminates of the invention which are intended for use in the interior of buildings or industrial installations, it comprises at least one flame retardant.

Examples of suitable flame retardants are halogenated, especially chlorinated, olefinically unsaturated monomers, especially acrylates or methacrylates, such as 3-chloro-2-hydroxypropyl methacrylate, which are incorporated into the three-dimensionally crosslinked matrix of the clearcoat during the curing with actinic radiation. Further examples of suitable flame retardants are brominated aliphatic or aromatic compounds, especially brominated aromatic compounds such as decabromodiphenyl ether or 1,2-bis-(pentabromophenyl)ethane. These compounds are substantially insoluble in the clearcoat material. They are therefore incorporated into the clearcoat material in the form of finely divided particulate solids with a particle size of from 1 to 30, preferably from 2 to 20, and in particular from 5 to 15 μm.

The flame retardants are used preferably in an amount of from 5 to 75, more preferably from 6 to 70, with particular preference from 7 to 70, with very particular preference from 8 to 65, and in particular from 10 to 60% by weight, based in each case on the overall amount of the clearcoat material.

Furthermore, the clearcoat material may comprise at least one additive such as customary and known oligomeric or polymeric binders which contain no radiation-curable group, organic solvents, light stabilizers such as UV absorbers, sterically hindered amines (HALS), phenolic antioxidants or quenchers; thermolabile free-radical initiators, devolatilizers, slip additives, polymerization inhibitors, defoamers, emulsifiers, wetting agents, dispersants, adhesion promoters, leveling agents, film forming auxiliaries, sag control agents, rheology control additives (thickeners), siccatives, dryers, antiskinning agents and/or corrosion inhibitors. Examples of suitable additives are described in detail in the textbook “Lackadditive” [Additives for Coatings] by Johan Bieleman, Wiley-VCH, Weinheim, N.Y., 1998, or in “Paints, Coatings and Solvents”, edited by Dieter Stoye and Werner Freitag, 2nd edition, Wiley-VCH, Weinheim, N.Y., 1998.

The preparation of the clearcoat material curable with actinic radiation has no special features in terms of its method but instead takes place in a customary and known manner by mixing of the above-described constituents in appropriate mixing equipment such as stirred vessels, dissolvers or extruders. It is preferred here to operate in the absence of light of a wavelength λ<550 nm, or in the complete absence of light, in order to prevent premature crosslinking of the clearcoat material.

The production of the clearcoat has no special features in terms of its method but instead takes place by application of the clearcoat material to the surface or the side of the foam layer which subsequently forms the top of the foam layer(s) upon use of the laminate of the invention. Alternatively, the clearcoat material is applied to the surface of a color and/or effect basecoat which is located on this surface of the foam layer(s).

This can be done by any customary application method, such as spraying, knife coating, brushing, flow coating, dipping, impregnating, trickling or rolling, for example. The shape to be coated, especially the panel, of foam may itself be at rest, with the application equipment or unit being moved. Alternatively, the substrate to be coated may be moved, with the application unit being at rest relative to the substrate or being moved appropriately. It is preferred here to operate in the absence of light with a wavelength λ<550 nm or in the complete absence of light, in order to prevent uncontrolled premature crosslinking of the clearcoat material.

The thickness of the applied clearcoat film may vary widely. It preferably has a thickness such that, after curing, the clearcoat has a dry film thickness of from 10 to 120, more preferably from 10 to 110, with particular preference from 10 to 100, with very particular preference from 10 to 90, and in particular from 10 to 80 g/m².

The curing of the clearcoat film may take place after a certain rest period. This period may have a duration of from 10 s to 2 h, preferably from 1 min to 1 h, and in particular from 1 min to 30 min. The rest period is used, for example, for leveling and for devolatilization of the clearcoat film or for the evaporation of volatile constituents such as solvents. The rest period may be assisted and/or shortened by the application of elevated temperatures up to 80° C., provided this does not entail any damage or change to the clearcoat film, such as uncontrolled premature crosslinking, for instance.

The curing with actinic radiation also has no special features in terms of its method but instead takes place with the aid of electromagnetic radiation such as near infrared, visible light, UV radiation or X-rays, especially UV radiation, and/or corpuscular radiation such as electron beams. It is preferred to employ UV radiation.

In the case of electron beams, it is preferred to operate under an inert gas atmosphere. This may be ensured, for example, by supplying carbon dioxide and/or nitrogen directly to the surface of the applied films. In the case of curing with UV radiation as well it is also possible to operate under inert gas in order to prevent the formation of ozone.

Curing with actinic radiation is carried out using the customary and known radiation sources and optical auxiliary measures. Examples of suitable radiation sources are high-pressure or low-pressure mercury vapor lamps, with or without lead doping in order to open up a radiation window up to 405 nm, or electron beam sources. Further examples of suitable radiation sources are described in the German patent application DE 198 18 735 A1, column 10 lines 31 to 61. The arrangement of these sources is known in principle and may be adapted to the circumstances of the substrate and the process parameters. In the case of foam layers of complex shape, those regions not accessible to direct radiation (shadow regions), such as cavities or other undercuts, may be cured using pointwise, small-area or all-round emitters, in conjunction with an automatic movement means for the irradiation of cavities or undercuts.

The equipment and conditions for these curing methods are also described, for example, in R. Holmes, U.V. and E.B. Curing Formulations for Printing Inks, Coatings and Paints, SITA Technology, Academic Press, London, United Kingdom, 1984.

Curing here may take place in stages, i.e., by multiple exposure to light or actinic radiation. It may also be carried out alternatingly, i.e., for example, by curing alternately with UV radiation and electron beams.

It is preferred to employ a radiation dose of from 1000 to 3000, more preferably from 1200 to 2900, and in particular from 1300 to 2800 mJ/cm². It is advisable to choose the radiation dose and period of irradiation such that, although the clearcoat film is fully cured, the foam layer is not damaged by the radiation. The skilled worker is able to optimize the parameters in each individual case on the basis of his or her general knowledge in the art, with the assistance of simple preliminary tests if necessary.

It is a substantial advantage of this process that even mechanically and/or thermally sensitive foam layers may be provided with the clearcoat. The resultant laminates of the invention are notable for an abrasion resistant, scratch resistant outer surface which is stable to weathering, so that it may not be easily damaged by mechanical or chemical effects during transport, during handling, or during its intended use. The laminates of the invention therefore have a considerably longer service life and need no longer be subjected to periodic inspection, with replacement if necessary. Moreover, the outer surface of the laminates of the invention has a particularly good overall appearance, and repels dirt.

In one preferred embodiment of the laminate of the invention, there is at least one, in particular one, basecoat between the underside of the above-described clearcoat and the outer skin of the outer foam layer. The basecoat may be prepared from any of a wide variety of basecoat materials, for example, from conventional basecoat materials or waterborne basecoat materials. Waterborne basecoat materials are used with preference.

Waterborne basecoat materials are known from the patent applications and patents EP 0 089 497 A1, EP 0 256 540 A1, EP 0 260 447 A1, EP 0 297 576 A1, WO 96/12747, EP 0 523 610 A1, EP 0 228 003 A1, EP 0 397 806 A1, EP 0 574 417 A1, EP 0 531 510 A1, EP 0 581 211 A1, EP 0 708 788 A1, EP 0 593 454 A1, DE-A-43 28 092 A1, EP 0 299 148 A1, EP 0 394 737 A1, EP 0 590 484 A1, EP 0 234 362 A1, EP 0 234 361 A1, EP 0 543 817 A1, WO 95/14721, EP 0 521 928 A1, EP 0 522 420 A1, EP 0 522 419 A1, EP 0 649 865 A1, EP 0 536 712 A1, EP 0 596 460 A1, EP 0 596 461 A1, EP 0 584 818 A1, EP 0 634 431 A1, EP 0 669 356 A1, EP 0 678 536 A1, EP 0 354 261 A1, EP 0 424 705 A1, WO 97/49745, WO 97/49747, EP 0 401 565 A1, DE 196 52 842 A1 or EP 0 817 684, column 5, lines 31 to 45, EP 0 787 195 A1, DE 40 05 961 A1, DE 41 10 520 A1, EP 0 752 455 B1, DE 198 55 455 B1, DE 199 488 121 A1, DE 198 469 171 A1, EP 0 788 523 B1 and WO 95/12626.

As is known, they comprise as basecoat binders at least one water-dispersible or soluble polyurethane and/or (meth)acrylate (co)polymer, in particular a (meth)acrylate polymer. The (meth)acrylate copolymers are commercially customary products and are sold, for example, under the brand name Acronal® by the company BASF Aktiengesellschaft or under the brand name Neocryl®.

The basecoat binders are preferably used in the form of aqueous solutions or dispersions, having a solids content of preferably from 10 to 80, more preferably from 15 to 70, and in particular from 20 to 60% by weight, based on the solution or dispersion.

The basecoat binders are preferably physically curing. This denotes the curing of a layer of a coating material by filming through loss of solvent from the coating material, with linking within the coating taking place by looping of the polymer molecules of the binders (regarding the term, cf. Römpp Lexikon Lacke und Druckfarben, Georg Thieme Verlag, Stuttgart, New York, 1998, “Binders”, pages 73 and 74). Or else filming takes place by the coalescence of binder particles (cf. Römpp, op. cit., “Curing”, pages 274 and 275). Normally, no crosslinking agents are required for this purpose. If desired, physical curing may be assisted by atmospheric oxygen, by heat, or by exposure to actinic radiation.

The amount of the above-described basecoat binders in the waterborne basecoat material may vary widely. It is preferably from 5 to 70, more preferably from 6 to 65, with particular preference from 7 to 60, with very particular preference from 8 to 55, and in particular from 9 to 50% by weight, based in each case on the solids of the waterborne basecoat material.

The basecoat material further comprises at least one organic and/or inorganic, color and/or effect pigment.

Examples of suitable effect pigments include metallic effect pigments such as standard commercial aluminum bronzes, aluminum bronzes chromated in accordance with DE 36 36 183 A1, and standard commercial stainless steel bronzes, and also nonmetallic effect pigments, such as pearlescent pigments and interference pigments, for example, platelet-shaped effect pigments based on iron oxide, having a shade from pink to brownish red, liquid-crystalline effect pigments or fluorescent pigments (daylight fluorescent pigments) such as bis(azomethine) pigments. For further details, reference is made to Römpp, op. cit., page 176, “Effect pigments” and pages 380 and 381, “Metal oxide-mica pigments” to “Metal pigments” and to the patents and patent applications DE 36 36 156 A 1, DE 37 18 446 A 1, DE 37 19 804 A 1, DE 39 30 601 A 1, EP 0 068 311 A 1, EP 0 264 843 A 1, EP 0 265 820 A 1, EP 0 283 852 A 1, EP 0 293 746 A 1, EP 0 417 567 A 1, U.S. Pat. No. 4,828,826 A or U.S. Pat. No. 5,244,649 A.

Preference is given to the use of metallic effect pigments, especially aluminum effect pigments (cf. Römpp op. cit., pages 24 and 25, “Aluminum pigments”).

The aluminum effect pigments are leafing pigments (cf. Römpp op. cit., page 351, “Leafing pigments”) or non-leafing pigments (cf. Römpp op. cit., page 412, “non-leafing pigments”). They are of platelet-shaped, substantially circular form (silver dollar type) or of platelet-shaped, substantially elongate form.

Examples of suitable inorganic color pigments are white pigments such as titanium dioxide, zinc white, zinc sulfide or lithopones; black pigments such as carbon black, iron-manganese black or spinel black; chromic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chrome orange; or yellow iron oxide, nickel titanium yellow, chrome titanium yellow, cadmium sulfide, cadmium zinc sulfide, chrome yellow or bismuth vanadate.

Examples of suitable organic color pigments are monoazo pigments, disazo pigments; anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments or aniline black.

For further details, reference is made to Römpp op. cit., pages 180 and 181, “Iron blue pigments” to “Black iron oxide”, pages 451 to 453, “Pigments” to “Pigment volume concentration”, page 563, “Thioindigo pigments”, page 567, “Titanium dioxide pigments”, pages 400 and 467, “Naturally occurring pigments”, page 459, “Polycyclic pigments”, page 52, “Azomethine pigments”, “Azo pigments”, and page 379, “Metal complex pigments”.

Examples of suitable electrically conductive pigments are titanium dioxide/tin oxide pigments.

Examples of suitable magnetically shielding pigments are magnetic pigments based on iron oxides or chromium dioxide.

Suitable soluble organic dyes are lightfast organic dyes having little or no tendency to migrate from the coating materials of the invention or from the coatings produced from them. The migration tendency may be estimated by the skilled worker on the basis of his or her general knowledge in the art and/or determined with the aid of simple preliminary range finding tests, as part of tinting experiments, for example.

Furthermore, the basecoat material may comprise organic and inorganic fillers.

Examples of suitable organic and inorganic fillers are chalk, calcium sulfates, barium sulfate, silicates such as talc, mica or kaolin, silicas, oxides such as pyrogenic silicon dioxide, which may also be used as a rheological agent, or aluminum hydroxide or magnesium hydroxide, and organic fillers such as polymer powders, especially of polyamide or polyacrylonitrile. For further details, reference is made to Römpp, op. cit., pages 250 ff., “Fillers”.

It may be of advantage to use mixtures of platelet-shaped inorganic fillers such as talc or mica and non-platelet-shaped inorganic fillers such as chalk, dolomite, calcium sulfates or barium sulfate, since by this means it is possible to adjust the viscosity and rheology effectively.

The above-described pigments, dyes and fillers may be present in a finely divided, nonhiding form.

The amount of the above-described pigments in the basecoat material may vary very widely and is guided in particular by the effects and/or colors which are to be imparted, and by the hiding power of the pigments. They are preferably employed in amounts such that the resulting pigment/basecoat binder ratio is from 1:1 to 10:1, more preferably from 1.2:1 to 6:1, with particular preference from 1.5:1 to 5:1, with very particular preference from 1.8:1 to 4:1, and in particular from 2.0:1 to 3:1.

Furthermore, the basecoat material may include the additives described above in connection with the clearcoat materials.

The preparation and the application of the basecoat material have no special features in terms of their method but instead take place in accordance with the methods described above in connection with the clearcoat materials, except that it is possible to operate in daylight. The basecoat material is preferably applied in a film thickness such that physical curing results in a basecoat having a dry film thickness of from 5 to 40, preferably from 6 to 38, more preferably from 7 to 36, with particular preference from 8 to 34, with very particular preference from 9 to 30, and in particular from 10 to 28 g/m².

The above-described preferred embodiment of the laminate of the invention is outstandingly suitable for decorative and insulating purposes in the interior and exterior of buildings. The basecoat allows the production of laminates of the invention having a virtually unlimited number of colors and/or optical effects, especially metallic and dichroic optical effects. The different colors and/or optical effects of the basecoat may, however, also be used quite generally for safety, especially workplace safety, through the use of laminates of the invention having warning colors and/or fluorescent colors at critical points of buildings or installations. However, in addition to the heat insulation, the laminates of the invention may also be used for electrical and/or magnetic shielding.

On the laminate of the invention based on foam layers consisting of or containing natural rubber or synthetic rubber, there is at least one adhesive film or adhesive sheet, especially a adhesive film or adhesive sheet, which is curable with actinic radiation, physically setting, contains nanoparticles and at least one tackifier and is situated on the side facing away from the clearcoat or from the basecoat and clearcoat, i.e., the underside of the foam layer or of the bottommost foam layer. The adhesive film or adhesive sheet is obligatory, if the foam layers do not consist of or contain natural rubber or synthetic rubber.

The adhesive film or adhesive sheet is produced from adhesives curable with actinic radiation and comprising

at least one tackifier,

at least one low molecular mass compound containing at least one reactive functional group containing a bond which can be activated with actinic radiation, and

nanoparticles.

The first essential constituent of the adhesive is at least one, in particular one, tackifier. Tackifiers is the term for polymeric adhesives additives which increase the tack of the adhesives, i.e., their inherent stickiness or self-adhesion, so that they adhere firmly to surfaces after short, slight pressure (cf. Ullmann's Encylopedia of Industrial Chemistry, CD-ROM, wiley VCH, Weinheim, 1997, “Tackifiers”).

The tackifier may comprise at least one inert polymer or a polymer curable with actinic radiation, in particular with UV radiation, which is soluble or dispersible in the low molecular mass compound.

Examples of suitable tackifiers are highly flexible resins selected from the group consisting of

homopolymers of alkyl (meth)acrylates, especially alkyl acrylates, such as poly(isobutyl acrylate) or poly(2-ethylhexyl acrylate), which are sold under the brand name Acronal® by the company BASF Aktiengesellschaft, under the brand name Elvacite® by the company Du Pont, under the brand name Neocryl® by the company Avecia, and as Plexigum® by the company Roehm;

linear polyesters, as commonly used for coil coating and sold, for example, under the brand name Dynapol® by the company Dynamit Nobel or under the brand name Skybond® by the company SK Chemicals, Japan;

linear difunctional oligomers, curable with actinic radiation and having a number average molecular weight of more than 2000, in particular from 3000 to 4000, based on polycarbonate diol or polyester diol, which is sold under the designation CN 970 by the company Craynor or the brand name Ebecryl® by the company UCB;

linear vinyl ether homopolymers and copolymers based on ethyl, propyl, isobutyl, butyl and/or 2-ethylhexyl vinyl ethers, sold under the brand name Lutonal® by the company BASF Aktiengesellschaft; and

nonreactive urethane-urea oligomers, prepared from bis(4,4-isocyanatophenyl)methane, N,N-dimethylethanolamine and diols such as propanediol, hexanediol or dimethylpentanediol, and sold, for example, by the company Swift Reichold under the brand name Swift Range® or by the company Mictchem Chemicals under the brand names Surkopack® and Surkofilm®.

Particular preference is given to the use of the nonlinear vinyl ether homopolymers and copolymers, especially preferably Lutonal® A50 and M40, in particular Lutonal® A50.

The tackifier content of the adhesive may vary widely. It is preferably from 5 to 80, more preferably from 8 to 75, with particular preference from 10 to 70, with very particular preference from 12 to 65, and in particular from 14 to 60% by weight, based in each case on the adhesive of the invention.

The further essential constituent of the adhesive is at least one, in particular at least two, low molecular mass compound(s). They contain at least one of above-described radiation-curable groups, especially acrylate groups.

Examples of suitable compounds of this kind are the low molecular mass compounds described above in connection with the clearcoat materials.

Examples of especially suitable compounds of this kind are monofunctional or difunctional acrylates, preferably of long-chain, substantially linear, aliphatic diols, such as

2-ethylhexanediol, butanediol, decanediol, tridecanediol, dimethylhexanediol, trimethylhexanediol or dodecanediol,

the abovementioned diols chain extended by methoxy, ethoxy or propoxy groups, or

polycaprolactonediols, poly(methylene oxides), poly(ethylene oxides) or poly(ethylene oxide-co-propylene oxides),

among which the monofunctional acrylates are used with particular preference.

The especially suitable compounds also include the acrylates of long-chain, substantially linear, aliphatic alcohols such as butanol, hexanol, octanol, decyl alcohol, lauryl alcohol or lauryl alcohol monoglycidyl ether, whose acrylate is sold under the designation CN152 by the company Cray Valley.

The especially suitable compounds further comprise the acrylates of cycloaliphatic alcohols, such as isobornyl alcohol, cyclohexanol, tert-butylcyclohexanol or dicyclopentadienemethanol, especially isobornyl alcohol.

Among the especially suitable compounds, particular preference is given to the use of the acrylates of long-chain, substantially linear, aliphatic alcohols and the acrylates of cycloaliphatic alcohols. Of these, the acrylates of cycloaliphatic alcohols have the particular advantage that they are particularly good solvents for the tackifiers which exhibit particularly good adhesion to rubbers and particularly good wettability for rubbers. They are therefore used with very particular preference.

Use is made in particular of mixtures of

(i) at least one, in particular one, monofunctional acrylate of a long-chain, substantially linear, aliphatic alcohol or of a diol, especially a monofunctional acrylate of a long-chain alcohol, and

(ii) at least one, in particular one, acrylate of a cycloaliphatic alcohol.

Especially, use is made of a mixture of lauryl alcohol monoglycidyl ether acrylate and isobornyl acrylate. The proportions in this case may vary widely; preference is given to the use of proportions of from 10:1 to 1:10, more preferably from 6:1 to 1:6, with particular preference from 1:4 to 4:1, with very particular preference from 2:1 to 1:2 and in particular from 1.5:1 to 1:1.5.

The amount of the above-described low molecular mass compounds in the adhesive may vary widely. It is preferably from 10 to 90, more preferably from 12 to 80, with particular preference from 14 to 70, with very particular preference from 16 to 60, and in particular from 18 to 50% by weight, based in each case on the adhesive of the invention.

The third essential constituent of the adhesive of the invention comprises nanoparticles. Examples of suitable nanoparticles are those described above in connection with the clearcoat materials.

The amount of solid nanoparticles in the adhesive may vary widely. It is preferably from 0.05 to 10, more preferably from 0.1 to 9, with particular preference from 0.2 to 8, with very particular preference from 0.3 to 7, and in particular from 0.4 to 6% by weight, based in each case on the adhesive.

The adhesive preferably also comprises at least one photoinitiator, as described above in connection with the clearcoat materials. Where used, the photoinitiators are present in the adhesive in an amount of preferably from 0.1 to 5, more preferably from 0.2 to 4.5, with particular preference from 0.3 to 4, with very particular preference from 0.4 to 3.5, and in particular from 0.5 to 3% by weight, based in each case on the adhesive.

Over and above this, the adhesive may comprise at least one of the additives described above in connection with the clearcoat material.

The preparation, application and curing of the adhesive present no special features in terms of their method; rather, the methods and apparatus described above in connection with the clearcoat materials and the clearcoats are employed.

In a first preferred variant of the preparation of the adhesive film, the adhesive is applied directly to the underside of the bottommost foam layer, or to the underside of the foam layer, after which the resulting adhesive layer is cured with actinic radiation.

In a second preferred variant of the preparation of the adhesive film, the adhesive is applied for the preparation of an adhesive sheet to at least one, in particular one, side of a preferably planar temporary support, and is cured. The temporary supports comprise materials having little or no adhesion to the adhesive sheets located on them, so that the sheets may be removed from the temporary support without damage. Examples of suitable materials are fluorinated plastics such as polytetrafluoroethylene or customary and known antiadhesion layers of silicones. The temporary supports preferably comprise films, because the assembly of adhesive sheet and temporary support may be wound up simply and stored as a-roll until it is used. In the case of their use as intended, the adhesive sheets are either laminated under pressure to the surface of the foam layers or else the adhesive sheets are laminated to the articles with which the laminates of the invention are to be joined, after which they are joined to the surface of the laminates of the invention. The temporary supports may be removed from the adhesive sheets of the invention before or after lamination.

A key advantage of the above-described preparation of adhesive films on the surface of the laminates of the invention is that, owing to the direct application of the adhesive films or the lamination of the adhesive sheets, the foam layers are not damaged mechanically or thermally.

The adhesive films and adhesive sheets adhere extraordinarily firmly to the underside of the foam layer, or to the underside of the bottommost foam layer, and to the articles to which they durably and firmly bond the laminates of the invention. Their chemical resistance and weathering stability are very good, so that they are also suitable for applications outdoors and/or in installations where aggressive chemicals or solvents are handled. Not least, the adhesive films and adhesive sheets are extremely heat-stable and do not lose their bond strength even after heating at 190° C. for six hours. As a result, they meet even strict safety provisions such as those applying to the use of materials in the interior and exterior of buildings or industrial installations. Since the adhesive films or adhesive sheets are physically settable, there is a risk neither of sticking to the packaging materials during transit or of damage during the connection of the laminates of the invention to the walls, for example, of buildings.

### EXAMPLES

### Preparation Example 1

### The Preparation of a Clearcoat Material for use in Accordance with the Invention

To prepare the clearcoat material for use in accordance with the invention, 35 parts by weight of a commerical urethane acrylate (CN 965 from Cray Valley), 35 parts by weight of a commercial polyether acrylate (Photomer 6891 from Cognis), 5.0 parts by weight of tridecyl acrylate, 20 parts by weight of aluminum hydroxide, 2.8 parts by weight of a mixture of a commercial light stabilizer based on triazine (Cytec® 1164 from Cytec) and a commercial light stabilizer based on a hindered amine (HALS; Sandovur® 3058) in a weight ratio of 1.5:1, 1.5 parts by weight of a commercial photoinitiator (Lucirin® 8893 from BASF Aktiengesellschaft), 0.5 part by weight of a further commercial photoinitiator (Irgacure® from Ciba), and 0.2 part by weight of a commercial leveling agent were mixed with one another.

### Preparation Example 2

### The Preparation of a Waterborne Basecoat Material for use in Accordance with the Invention

To prepare the waterborne basecoat material for use in accordance with the invention, 30 parts by weight of a commercial dispersion of a methacrylate copolymer (Neocryl® A 1039; 40% in water), 0.2 part by weight of a commercial wetting agent (Surfynol® 104 from Air Products), 0.3 part by weight of a commercial pyrogenic silica (Aerosil® 200), 2.5 parts by weight of a commerical film forming auxiliary, 30 parts by weight of a 70% dispersion of titanium dioxide in water, and 37 parts by weight of a 50% dispersion of red iron oxide in water were mixed with one another.

### Preparation Example 3

### The Preparation of a Clearcoat Material for use in Accordance with the Invention to Produce a Flame-Retarded Clearcoat

The clearcoat material for use in accordance with the invention was prepared by mixing 33.9 parts by weight of a commercial polyether acrylate (Photomer 6891 from Cognis), 3.0 parts by weight of 3-chloro-2-hydroxypropyl methacrylate, 2 parts by weight of isobornyl acrylate, 25 parts by weight of aluminum hydroxide, 35 parts by weight of decabromodiphenyl ether with a particle size of 10 μm, 1.0 part by weight of a commercial photoinitiator (Lucirin® 8893 from BASF Aktiengesellschaft), and 0.1 part by weight of a commercial film forming auxiliary.

### Preparation Example 4

### The Preparation of an Adhesive for use in Accordance with the Invention

An adhesive for use in accordance with the invention was prepared by mixing 32 parts by weight of lauryl alcohol glycidyl ether acrylate, 32 parts by weight of isobornyl acrylate, 32 parts by weight of a commercial vinyl ether polymer (Lutonal® A50 from BASF Aktiengesellschaft), 1.0 part by weight of a commercial photoinitiator based on phosphine oxide, 0.2 part by weight of a commercial light stabilizer or antioxidant (Anox® IC 14 from Great Lakes), and 5.6 parts by weight of a 50% dispersion of nanoparticles in isopropanol (High Link® OG 502-31 from Clariant) and removing the isopropanol by distillation under reduced pressure. The adhesive was liquid and easy to apply.

### Example 1

### The Production of an Inventive Laminate 1

SBR foam panels as commonly used for insulating buildings were coated on one side with a layer of the clearcoat material of Preparation Example 1. The material was applied by rolling. The thickness of the clearcoat film was adjusted so that curing thereof resulted in clearcoats with a dry film thickness of from 30 to 50 g/m². Curing was carried out using lead-doped mercury vapor lamps and radiation doses of 2000 mJ/cm².

The inventive laminates 1 comprising foam panel and clearcoat could be packaged without problems and transported to the intended location without any damage to the surface. They could be joined to the outer walls of buildings without problems, using gentle pressure. Annual inspection of the inventive laminates 1 was no longer necessary, owing to their abrasion resistant, scratch resistant and weathering stable surface.

### Example 2

### The Production of an Inventive Laminate 2 for Interior Application

Example 1 was repeated but using the clearcoat material of Preparation Example 3 rather than the clearcoat material of Preparation Example 1, and making the dry film thickness of the clearcoat from 10 to 20 g/m². The resultant inventive laminates 2 were not only abrasion resistant and scratch resistant but also flame resistant, so making them outstandingly suitable for interior use in buildings or industrial installations.

### Example 3

### The Production of an Inventive Laminate 3 for Interior Use

Example 2 was repeated, but prior to the application of the clearcoat the waterborne basecoat material of Preparation Example 2 was applied in a dry film thickness of 15 g/m², by spraying. Thereafter the clearcoat was applied and cured as described. The resulting inventive laminates 3 were not only abrasion resistant and scratch resistant but also flame resistant and had a very good overall appearance, so making them outstandingly suitable for interior use in buildings or industrial installations. Because of their intense color, they also have a high signal effect, and so may be used as safety markings as well.

### Example 4

### The Production of an Inventive Laminate 4 for Exterior Application

Example 1 was repeated except that, before the inventive laminates 1 were used, a layer of the adhesive in accordance with the Preparation Example 4 was applied by rolling to their side facing away from the clearcoat. The thickness of the adhesive films was adjusted so that their curing resulted in adhesive films with a dry film thickess of from 60 to 65 g/m². Curing was carried out using lead-doped mercury vapor lamps and radiation doses of 2000 mJ/cm².

The inventive laminates 4 could be packaged without problems and transported to the intended location. They could be joined without problems, using gentle pressure, to walls, after which they adhered very firmly and durably to said walls. Even after heating of the laminates at 190° C. for six hours, there was no fall in bond strength. Otherwise, the inventive laminates 4 had the same advantages as the inventive laminates 1.

### Example 5

### The Production of an Inventive Laminate 5 for Exterior Application

Example 2 was repeated except that, before the inventive laminates 2 were used, a layer of the adhesive in accordance with the Preparation Example 4 was applied by rolling to their side facing away from the clearcoat. The thickness of the adhesive films was adjusted so that their curing resulted in adhesive films with a dry film thickess of from 60 to 65 g/m². Curing was carried out using lead-doped mercury vapor lamps and radiation doses of 2000 mJ/cm².

The inventive laminates 5 could be packaged without problems and transported to the intended location. They could be joined without problems, using gentle pressure, to walls, after which they adhered very firmly and durably to said walls. Even after heating of the laminates at 190° C. for six hours, there was no fall in bond strength. Otherwise, the inventive laminates 5 had the same advantages as the inventive laminates 2.

### Example 6

### The Production of an Inventive Laminate 6 for Exterior Application

Example 3 was repeated except that, before the inventive laminates 3 were used, a layer of the adhesive in accordance with the Preparation Example 4 was applied by rolling to their side facing away from the clearcoat. The thickness of the adhesive films was adjusted so that their curing resulted in adhesive films with a dry film thickess of from 60 to 65 g/m². Curing was carried out using lead-doped mercury vapor lamps and radiation doses of 2000 mJ/cm².

The inventive laminates 6 could be packaged without problems and transported to the intended location. They could be joined without problems, using gentle pressure, to walls, after which they adhered very firmly and durably to said walls. Even after heating of the laminates at 190° C. for six hours, there was no fall in bond strength. Otherwise, the inventive laminates 6 had the same advantages as the inventive laminates 3.

### Example 7

### The Production of an Inventive Laminate 7 for Exterior Application

Example 4 was repeated except that, before the inventive laminates 4 were used, a layer of the adhesive in accordance with the Preparation Example 4 was applied by rolling to their side facing away from the clearcoat. The thickness of the adhesive films was adjusted so that their curing resulted in adhesive films with a dry film thickness of from 60 to 65 g/m². Curing was carried out using lead-doped mercury vapor lamps and radiation doses of 2000 mJ/cm².

The inventive laminates 7 could be packaged without problems and transported to the intended location. They could be joined without problems, using gentle pressure, to walls, after which they adhered very firmly and durably to said walls. Even after heating of the laminates cut 190° C. for six hours, there was no fall in bond strength. Otherwise, the inventive laminates 7 had the same advantages as the inventive laminates 4.

What is claimed is:

1. A foam laminate comprising at least one layer of a foam sealed by an outer skin consisting of or containing natural rubber or synthetic rubber and at least one clearcoat cured with actinic radiation.

2. The foam laminate as claimed in claim 1, wherein the foam layer comprises or consists of a styrene-butadiene rubber.

3. The foam laminate as claimed in claim 1 or 2, which is covered with an adhesive film on its side facing away from the clearcoat, wherein the adhesive film is curable with actinic radiation, is physically setting, contains nanoparticles and at least one tackifier.

4. A foam laminate comprising at least one layer of a foam sealed by an outer skin consisting, at least one clearcoat cured with actinic radiation and an adhesive film on its side facing away from the clearcoat, said adhesive film being curable with actinic radiation, physically setting, containing nanoparticles and at least one tackifier.

5. The foam laminate as claimed in claim 4, wherein the foam layer(s) is or are elastic or flexible.

6. The foam laminate as claimed in any of claims 1 to 5, wherein at least its side facing away from the clearcoat is substantially or completely planar.

7. The foam laminate as claimed in any of claims 1 to 6, which is planar overall.

8. The foam laminate as claimed in any of claims 1 to 7, wherein there is at least one color and/or effect basecoat between the outer skin of the foam layer or outer foam layer and the underside of the clearcoat.

9. The foam laminate as claimed in any of claims 1 to 8, wherein at least one of the clearcoats contains at least one transparent filler.

10. The foam laminate as claimed in any of claims 1 to 9, wherein the clearcoat or at least one of the clearcoats and/or the basecoat comprise or comprises at least one flame retardant.

11. A method of producing the foam laminate as claimed in any of claims 1 to 3, wherein at least one clearcoat material curable with actinic radiation is applied to the outer skin of one side of the foam layer, or one side of the outer foam layer, consisting of or containing natural rubber or synthetic rubber, or to a color and/or effect coating which is present thereon, and cured with actinic radiation.

12. The method as claimed in claim 11, wherein an adhesive curable with actinic radiation is applied to side of the foam layer(s) facing away from the clearcoat or basecoat and clearcoat and the resulting adhesive film is cured with actinic radiation or alternatively the adhesive is applied to a temporary support, the resulting adhesive film is cured with actinic radiation and the resulting physically setting, self-supporting adhesive sheet, is joined to said side of the foam layer(s) before or after its removal from the temporary support.

13. The method as claimed in any of claims 4 to 10, wherein
(i) at least one clearcoat material curable with actinic radiation is applied to the outer skin of one side of the foam layer, or one side of the outer foam layer, or to a color and/or effect coating which is present thereon, and cured with actinic radiation and
(ii) an adhesive curable with actinic radiation is applied to side of the foam layer(s) facing away from the clearcoat or basecoat and clearcoat and the resulting adhesive film is cured with actinic radiation or alternatively the adhesive is applied to a temporary support, the resulting adhesive film is cured with actinic radiation and the resulting physically setting, self-supporting adhesive sheet, is joined to said side of the foam layer(s) before or after its removal from the temporary support.

14. The method as claimed in any of claims 11 to 13, wherein the at least one clearcoat material curable with actinic radiation comprises
at least one binder comprising on average per molecule at least one reactive functional group containing a bond which can be activated with actinic radiation (“clearcoat binder”),
at least one low molecular mass compound containing at least one reactive functional group containing a bond which can be activated with actinic radiation (“reactive diluent”), and at least one photoinitiator.

15. The method as claimed in any of claims 11 to 14, wherein the at least one clearcoat material curable with actinic radiation comprises at least one transparent filler and/or one flame retardant.

16. The method as claimed in any of claims 11 to 15, wherein the adhesive curable with actinic radiation comprises
at least one tackifier,
at least one low molecular mass compound containing at least one reactive functional group containing a bond which can be activated with actinic radiation (“reactive diluent”), and
nanoparticles.

17. The method as claimed in claim 16, wherein the adhesive comprises at least one photoinitiator.

18. The method as claimed in any of claims 14 to 17, wherein the color and/or effect basecoat is producible by applying at least one physically curing color and/or effect aqueous basecoat material comprising
at least one water-dispersible or water-soluble, physically curing binder (“basecoat binder”) and
and least one color and/or effect pigment
to the outer skin of the foam layer, or of the outer foam layer, and physically curing the resulting basecoat(s).

19. The method as claimed in any of claims 14 to 18, wherein the bonds which can be activated with actinic radiation are selected from the group consisting of carbon-hydrogen single bonds or carbon-carbon, carbon-oxygen, carbon-nitrogen, carbon-phosphorus or carbon-silicon single bonds or double bonds.

20. The method as claimed in claim 19, wherein carbon-carbon double bonds (“double bonds”) are used.

21. The method as claimed in claim 20, wherein the double bonds are present in the form of (meth)acrylate, ethacrylate, crotonate, cinnamate, vinyl ether, vinyl ester, ethenylarylene, dicyclopentadienyl, norbornenyl, isoprenyl, isopropenyl, allyl or butenyl groups; ethenylarylene ether, dicyclopentadienyl ether, norbornenyl ether, isoprenyl ether, isopropenyl ether, allyl ether or butenyl ether groups or ethenylarylene ester, dicyclopentadienyl ester, norbornenyl ester, isoprenyl ester, isopropenyl ester, allyl ester or butenyl ester groups.

22. The use of the foam laminate as claimed in any of claims 1 to 10 or produced by any one of the claims 11 to 21 for the decorative, signaling and/or thermally, magnetically and/or electrically insulating coating of articles.

23. The use of the foam laminate as claimed in claim 22, wherein the articles comprise buildings, industrial installations, or parts thereof.
